(19) United States
(12) Patent Application Publication
(10) Pub. No.: US 2016/0162944 A1
(43) Pub. Date: Jun. 9, 2016

(54) METHOD AND APPARATUS FOR PHILANTHROPY

(71) Applicant: Craig LAWRENCE, Listowel (CA)

(72) Inventor: Craig LAWRENCE, Listowel (CA)

(21) Appl. No.: 14/957,901

(22) Filed: Dec. 3, 2015

Related U.S. Application Data
(60) Provisional application No. 62/086,770, filed on Dec. 3, 2014.

(51) Int. Cl. G06Q 30/02; H04N 21/475; H04N 21/258; G06Q 20/40; H04N 21/81

(52) U.S. Cl. CPC G06Q 30/0257; G06Q 30/0279; G06Q 20/405; H04N 21/812; H04N 21/25891; H04N 21/4758

(57) ABSTRACT

A method and system for providing a philanthropy tool which includes an apparatus which allows a user to translate their time resources into a financial donation to a selected charity. A user interacts with advertising content and then completes a quiz relating to the advertising content. Upon confirmation that the user has viewed the advertising content, a donation, on behalf of the user, is forwarded to the selected charity by the system.

### CROSS-REFERENCE TO RELATED APPLICATIONS

This application claims the benefit of U.S. Provisional Patent Application No. 62/086,770, filed Dec. 3, 2014, which is incorporated by reference.

### FIELD OF THE DISCLOSURE

The present application relates generally to philanthropy. More particularly, the present disclosure relates to a method and apparatus for philanthropy.

### BACKGROUND OF THE DISCLOSURE

In the world of charities and non-profits, these organizations are regularly trying to figure out new ways to reach out to possible donors. Old-fashioned methods of fund-raising such as by using mailers or fund-raising events are still beneficial and a source of considerable donations. However, with the continuing influence of technology in today's society, new ways to reach possible donors are being contemplated and created.

Therefore, there is provided a novel method and apparatus for philanthropy.

### SUMMARY OF THE DISCLOSURE

It is an aspect of the disclosure to provide a method and apparatus for philanthropy. The method and apparatus merges technology with new ways of allowing donors to donate to charities and non-profits. The disclosure provides a system for users to make donations to charities by donating their time interacting with media files such as, but not limited to, listening to audio files or watching video files related to advertising content rather than using their own money. In one embodiment, the user answers at least one question based on the advertising content before an advertiser, or entity, associated with the advertising content makes a donation to the charity of the user's choice pending correct answers to the at least one question. The question or questions provide an aspect of confirmation that the user did indeed watch and comprehend the advertising content or commercial.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1a is a schematic diagram of apparatus for philanthropy;

FIG. 1b is a schematic diagram of a system for data collection and processing;

FIG. 2 is a flowchart outlining a method of philanthropy in accordance with an embodiment of the disclosure;

FIG. 3 is a schematic diagram of an embodiment of a workflow for a user;

FIG. 4 is a schematic diagram of an embodiment of a workflow for an advertiser;

FIGS. 5a to 5r are example screen shots of the system for a user;

FIGS. 6a to 6f are example screen shots of the system for an advertiser;

FIG. 7a is an example of a charity profile registration screen; and

FIGS. 8a to 8h are screen shots of a gameified version of the system.

### DETAILED DESCRIPTION

Generally, the present disclosure provides a method and apparatus for philanthropy. The method and apparatus provide for a system where a user can translate their time interacting with advertising content into donations to a selected charity or non-profit. In the following description, the term charity will serve to represent both charities and non-profit organizations. By donating their time watching advertising content, such as, but not limited to, commercials, and then providing confirmation that they have watched the advertising content, the user may have their time resources translated into financial resources or a donation for a selected charity. The financial portion of the donation is preferably provided by an advertiser, owner, or entity, associated with the advertising content that the user watched.

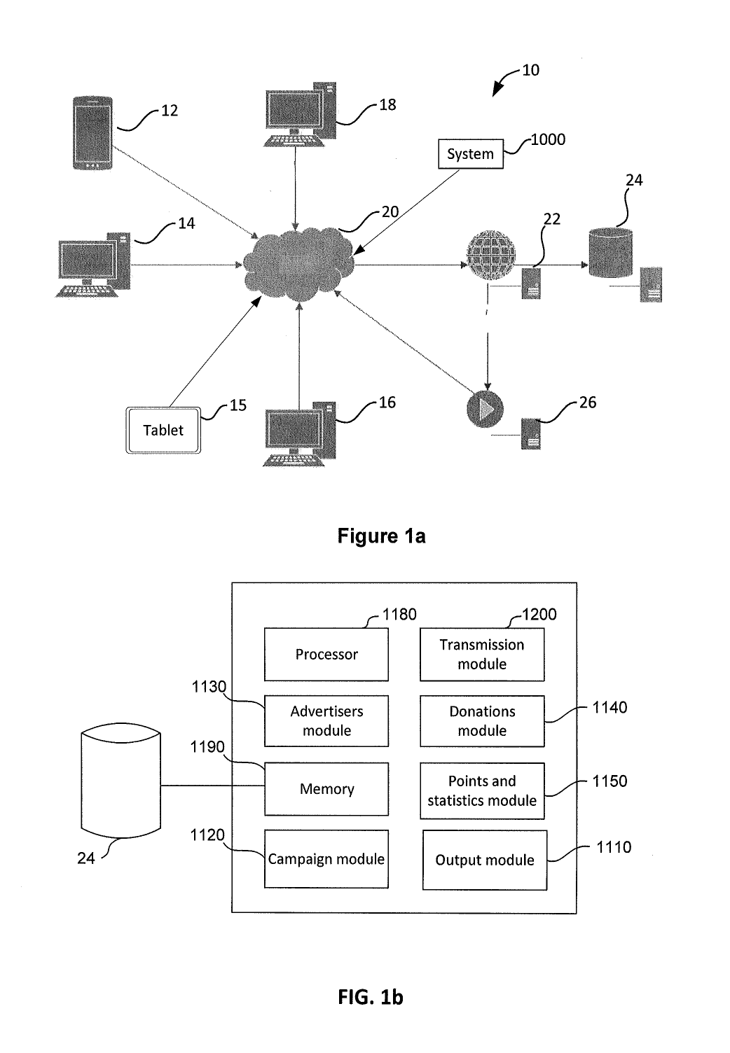

Turning to FIG. 1, a schematic diagram of apparatus for philanthropy is shown. In the current embodiment, the system 10 includes different types of participants, namely a user or watcher (represented by mobile device 12, desktop 14 or tablet 15), an owner of advertising content or advertiser (represented by advertiser desktop 16) and an administrator (represented by administrator desktop 18). In some embodiments, the administrator is part of the system 10. The use of a picture of a desktop computer for the user, administrator and advertiser is for display purposes only. In operation, the desktops may also be laptops or the like. Similarly the mobile device 12 may be a cellular telephone or a smartphone or the like. It will be understood that the system may include any number of users and advertisers.

The system 10 further includes a network 20, such as the Internet, to enable communication between the three types of participants. Other examples of a network include, but are not limited to, a Local Area Network (LAN), a Virtual Local Area Network (VLAN), a Wide Area Network (WAN), a Virtual Private Network (VPN), or the like. A web server 22, a database 24 and a media server 26, such as a video server are also connected directly, or indirectly to the network 20. The web server 22 may store statistics relating to the users and advertisers or may store demographic information relating to the users and advertisers. The web server 22 may also store the modules for allowing the user to access the content or data which is stored in the database 24 or the media server 26. The database 24 may store data such as, but not limited to, user statistics, user login information, advertiser login information and/or a list of supported charities. The media server 26 is used to store the advertising content for the advertisers.

A system 1000 may be partly incorporated in the web server 22 or the media server 26 or may be configured using a stand-alone network device operatively connected to one or more servers. The operative connection may be via a direct connection or via the network 20. The system 1000 may also be operatively connected to at least one external database 24. The system 1000 may query the database 24 and may retrieve electronic content from the database 24. In a preferred embodiment, an application is stored on each of the user devices 12, 14 or 15 which allows the user to interact with the system 1000 to access the system for philanthropy.

FIG. 1b illustrates the system 1000 for philanthropy according to an embodiment. The system 1000 includes an output module 1110, a campaign module 1120, an advertiser's module 1130, a donations module 1140 and a points and statistics module 1150. The system 1000 also includes a processor 1180, a memory module 1190, and a transmission module 1200.

The output module 1110 is configured to create or produce display screens which are to be displayed on the user depending on the action being performed by the user. The output module communicates with the processor 1180 or the database 24 or both to obtain the content for the display screen or page.

The campaign module 1120 determines the advertising content to be displayed to the user once a user has accessed the system for philanthropy. The campaign module may also determine the quiz to be displayed to a user once they have watched the advertising content. The campaign module 1120 communicate with the processor 1180, the database 24 or the output module 1140, or any combination of these three to determine the information to be delivered for display on the user's device by the system 1000.

The advertiser's module 1130 is configured to determine the value of a donation based on the actions of a user. In another embodiment, the advertiser's module 1130 and the campaign module 1120 may be combined as a single module.

The donations module 1140 is configured to transmit a donation from the system to a selected charity once confirmation is received from either the campaign module or the advertiser's module, or both that a user has confirmed that they have watched the advertising content.

The points and statistics module 1150 is configured to calculate points that a user has earned based on, in one embodiment, the user's engagement with the system 1000. The user's statistics such as the value of their donations may also be determined and stored by the points and statists module 1150. The points and statistics module 1150 may also assist in the gameifying of the system for philanthropy as discussed below.

The system 1000 further includes the processor 1800. The processor 1180 is configured to execute instructions from the other modules of the system 1000. In some cases, the processor 1180 may be a central processing unit. In other cases, each module may be operatively connected to a separate processor. The system further includes a memory module 1190, for example a database, random access memory, read only memory, or the like.

The transmission module 1200 is configured to receive and transmit data to and from the network 20 or the like. The transmission module 1200 may be, for example, a communication module configured to communicate between another device and/or the network 20. The transmission module 1200 may receive or intercept a request from a user, via the network, to access the system 1000. In some cases, the user request may be directed to the system 1000.

In one mode of operation, one of the users can watch advertising content, such as commercials, which are associated with an advertiser, which results in donations being made to at least one charity selected by the user. In other words, a user can translate their time resources, spent watching advertising content, into a financial donation to a selected charity. As will be described below, the advertiser 16 provides and uploads their advertising content to the media server 26 and creates an appropriate quiz for the user to answer after they have watched the advertising content.

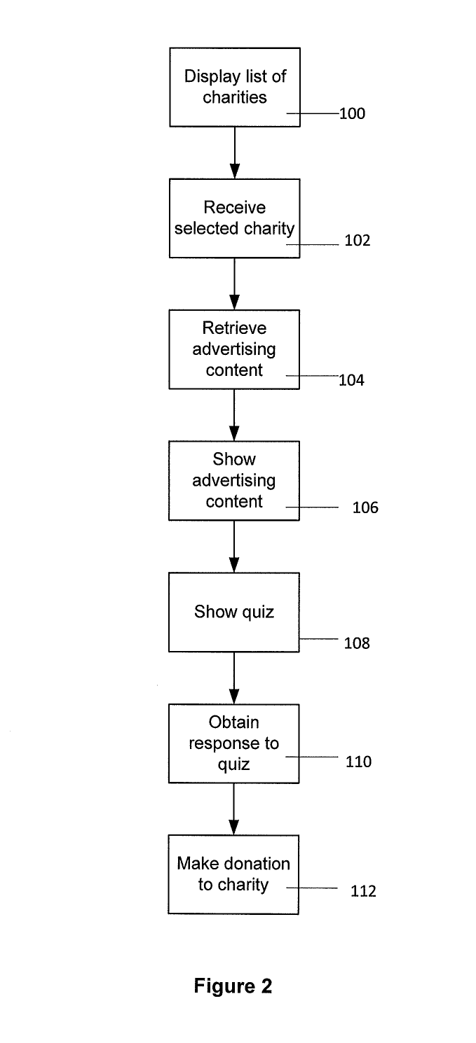

Turning to FIG. 2, a flowchart outlining a method of philanthropy is shown. When a user (either through a mobile device 12, a desktop 14, a tablet 15 or the like) wishes to engage the system 10, the user interacts with the web server 22 (which may be a central processing unit (CPU)) over the network 20. This may be achieved by opening an application on the user's device or the application may be executed from the web server 22.

The user is then prompted to login to the system. Alternatively, the user may also be previously logged into the system. The user may either log in using their email address, user identification or possibly via a social media account, such as, but not limited to, Facebook™. In the current flowchart, it is assumed that the user has already performed the necessary steps to register to use the system. Registration may include the submission of demographic information.

After confirming the user's login, the user is then prompted to select the charity or charities that they wish to donate to by reviewing a list of charities which is displayed on their device 12, 14 or 15 by the system (100). The user may then browse the list of charities to select a charity that the user wishes to donate to. Charities can preferably be browsed by category or through a search option. In one embodiment, the user may review details of those charities and information about the charities so that the user can determine which charity they wish to support. In another embodiment, the selection of a charity may occur before the user has logged in but will be prompted to login once a charity is selected.

This selection is received (102) by the system 10. The system 10 then retrieves advertising content (104) from the video server 26 and shows the advertising content (106) to the user on the user's connected device 12, 14 or 15. The advertising content may be selected based on the demographic information of the user as submitted during the registration process in order to provide advertising content that is more relevant to the user.

After receiving notification or confirmation that the user has completed interacting or watching the advertising content, the system transmits a quiz (108), preferably multiple choice, associated with the viewed advertising content to the user. After receiving the correct answers or responses (110) from the user, the system then makes a donation from the advertiser associated with the advertising content that was watched to the selected charity or one of the selected charities (112). The donation amount is determined by the value associated to the advertising content by the advertiser. These values may be predetermined.

Alternatively, after confirmation that the user has passed the quiz, the system may assign a donation value to the user based on the passing of the quiz and then add the donation value to a donation total that has been previously amassed by the user. As briefly disclosed above, the donation value may be previously assigned by an advertiser when creating a campaign (as will be described below). The system then connects with a server associated with the charity to enable the donation. In order to track the donation, the system may also provide the user's demographic information to the charity in order for the charity to issue tax receipts.

In order to maintain relevant advertising content, such as holiday campaigns or new products, the advertiser 16 is able to upload advertising content, in the form of video commercials and the like to the media server, and then manage this advertising content through a software application on a computer or tablet and the like. In a preferred embodiment, the application is web-based. Each campaign may have a start and end date and upper limit on the number of views. With respect to the donations from the advertiser to charities, in one embodiment, the advertiser may be billed based on the number of views at the end of the month using an agreed upon clearinghouse such as a credit card on file.

The administrator 18 may be in the form of an individual but is preferably part of the system, or web server. In a preferred embodiment, the administrator is able to monitor system statistics such as number of watchers, advertisers, commercials, charities etc. The administrator may also generate a report to show the amount of money owed to the charities.

The web server can be used to control and communicate with the video server(s) or the database. In a preferred embodiment, the web server communicates with the watcher, advertiser and administrator though a collection of APIs (application video interface).

In one embodiment, the system 10 is for use on mobile devices such as, but not limited to, smartphones, laptops or tablets, or desktop computing devices, executing system software or via software applications having the system software integrated within.

As disclosed above, various functionality available to the users, or watchers, include signing-up or registering for the system, searching for charities, watching video commercials and having donations made on their behalf. The software application executing on the mobile device or desktop requires connectivity to a network (such as the Internet) in order to function and may include a set of screens that are used to manage user profiles, advertising content viewing, quizzes and the user's history of interaction with the system.

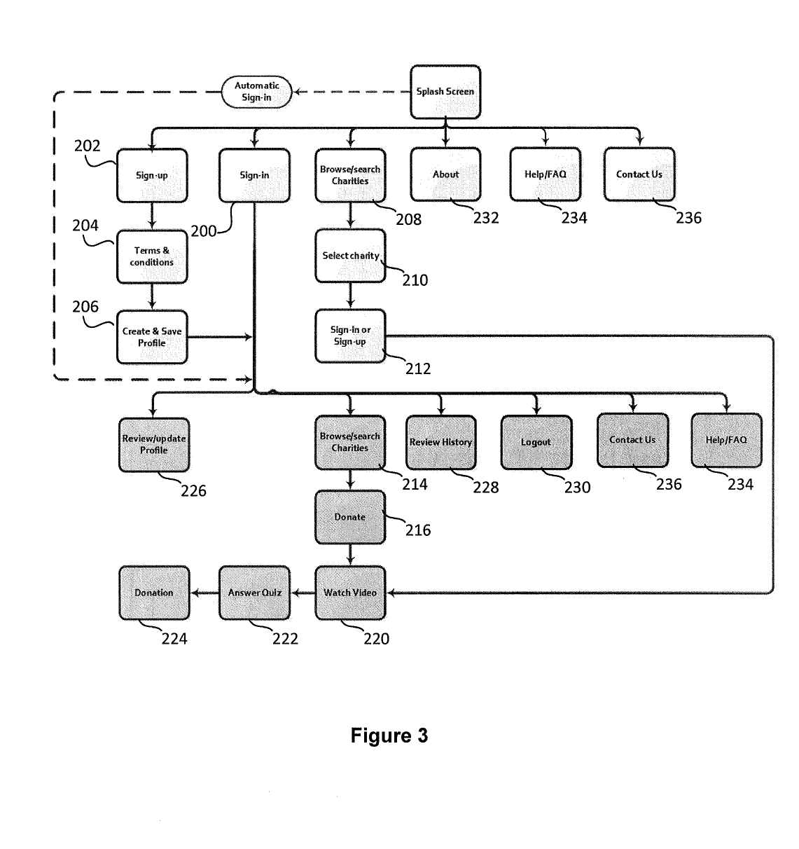

As shown in FIG. 3, a schematic diagram of how a user interacts with the system in one particular embodiment is shown. FIG. 3 may also be seen as a general organization of the workflow for the user's interaction with the system. When the system is initiated, a splash screen is preferably displayed by the system on a user's device. After the splash screen is displayed, the user may then be presented with a menu containing a list of options. These options may include, but are not limited to, a Sign-in or Login functionality which asks for a user identification and password along with a provision to recover password if the user has forgotten it; a Sign-up functionality which asks a user to insert a new userid and password and then provides a profile entry page for the use to fill out; a Search functionality whereby the system displays a page with charity search options and then displays a list of charities; an About functionality whereby the system displays a page that provides a brief description about the software application or system; a Contact Us functionality whereby the system displays contact information along with an email address and/or phone number; and a Help/FAQ functionality where the system displays at least one screen that describes the system and how it works.

Further assistance may be provided if the user has logged in previously, without logging out such that may be taken to a main screen menu (the shaded blocks in FIG. 3) when they engage the system.

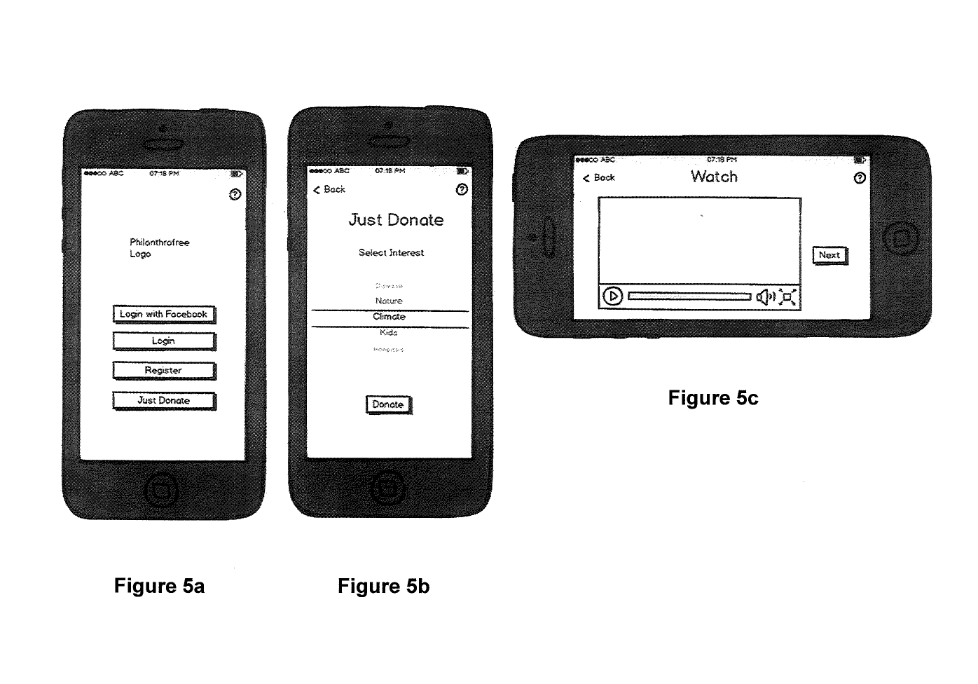

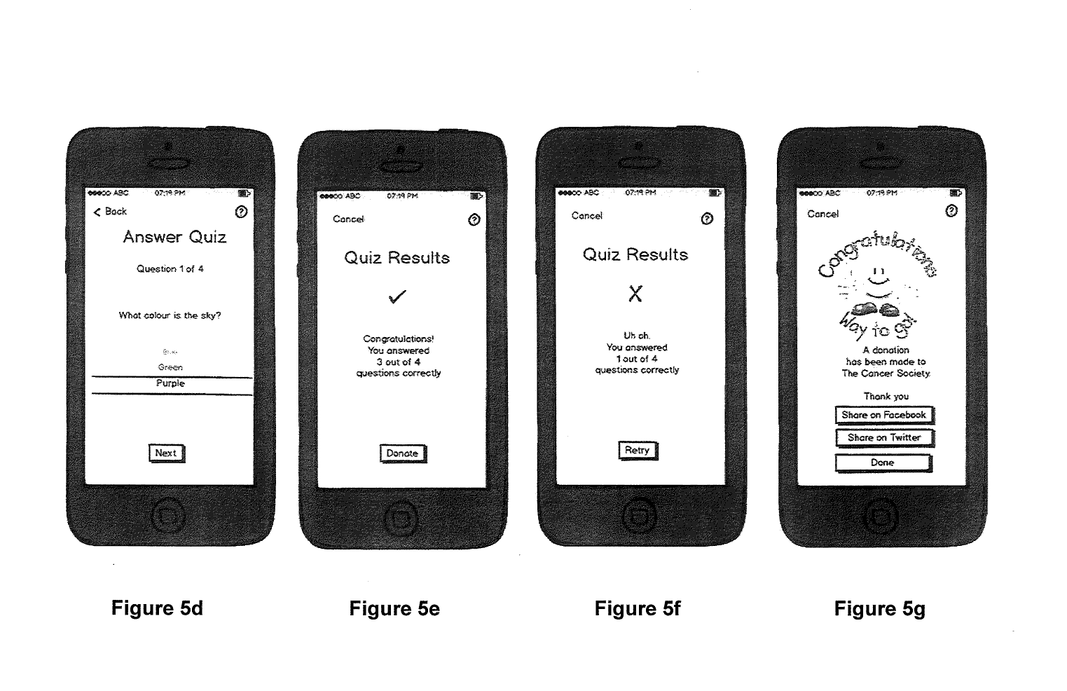

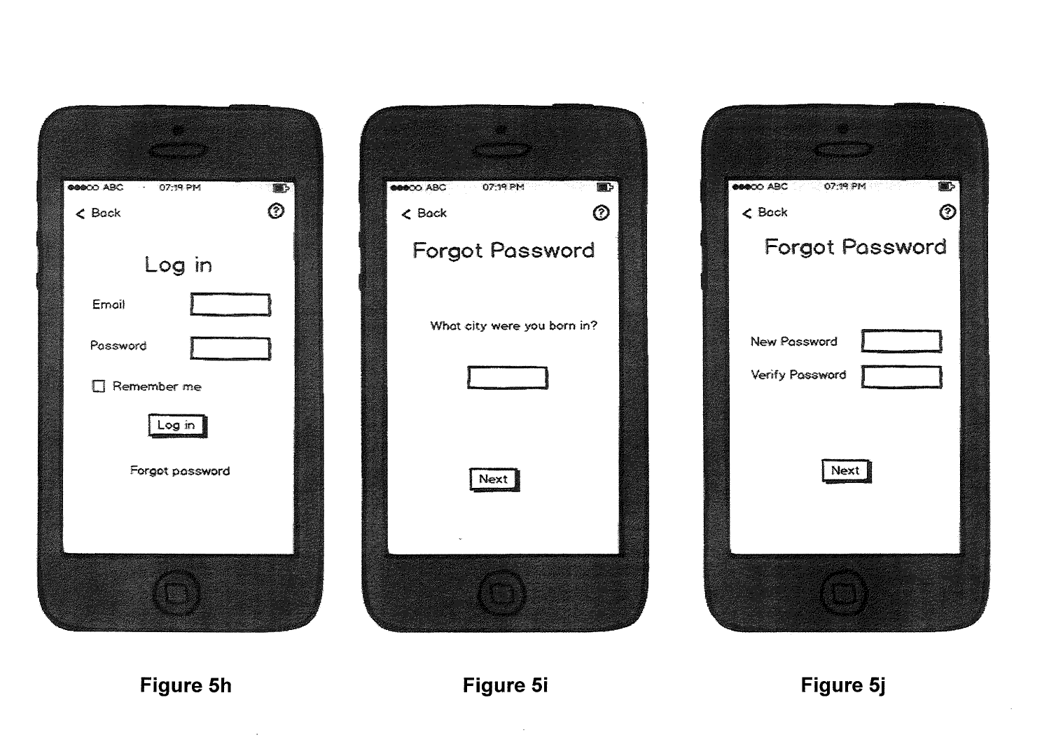

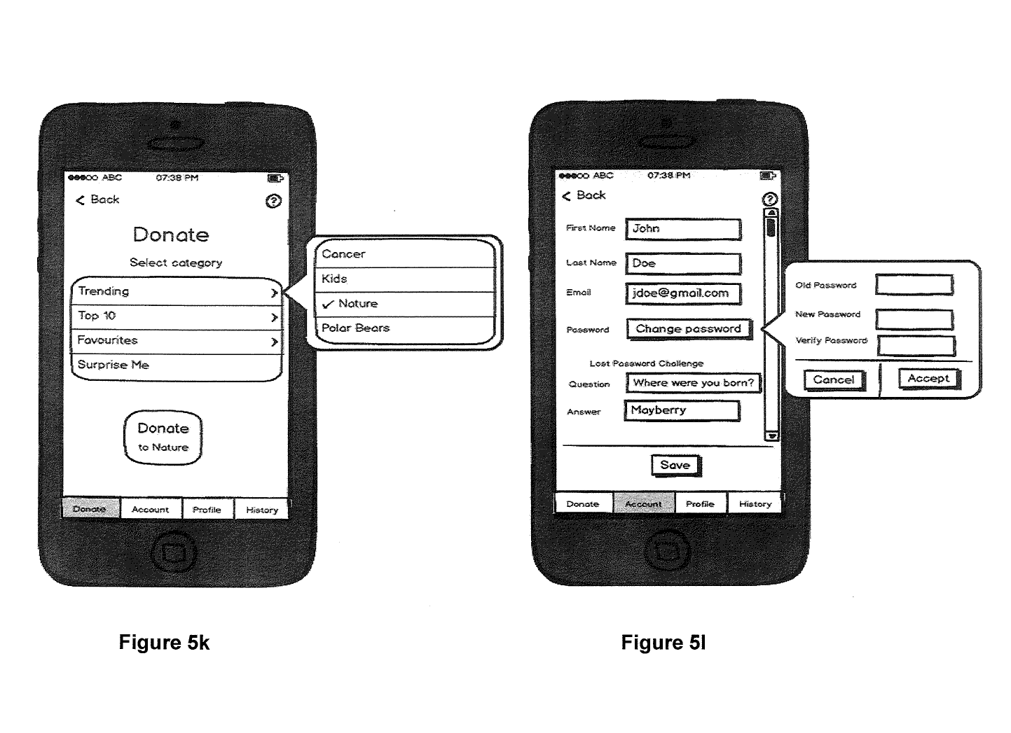

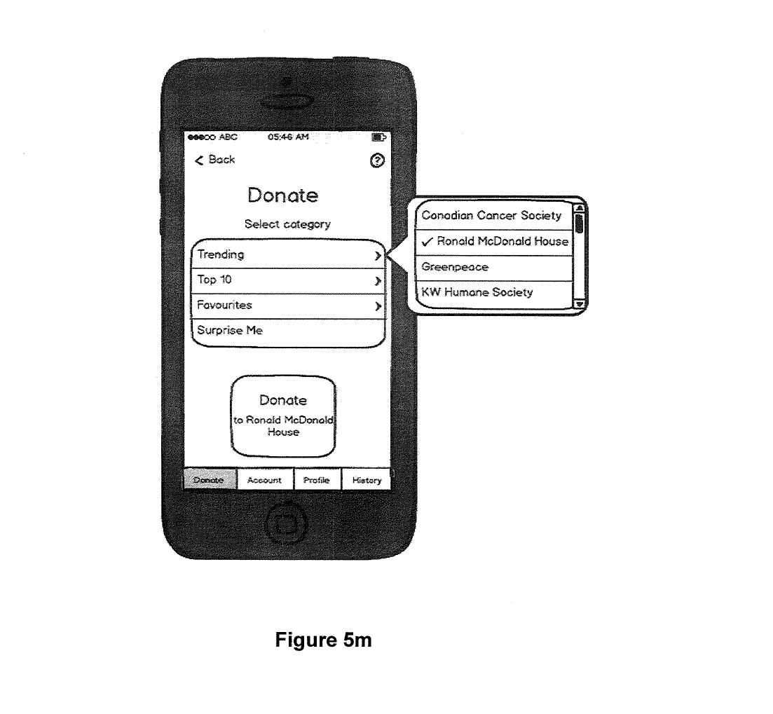

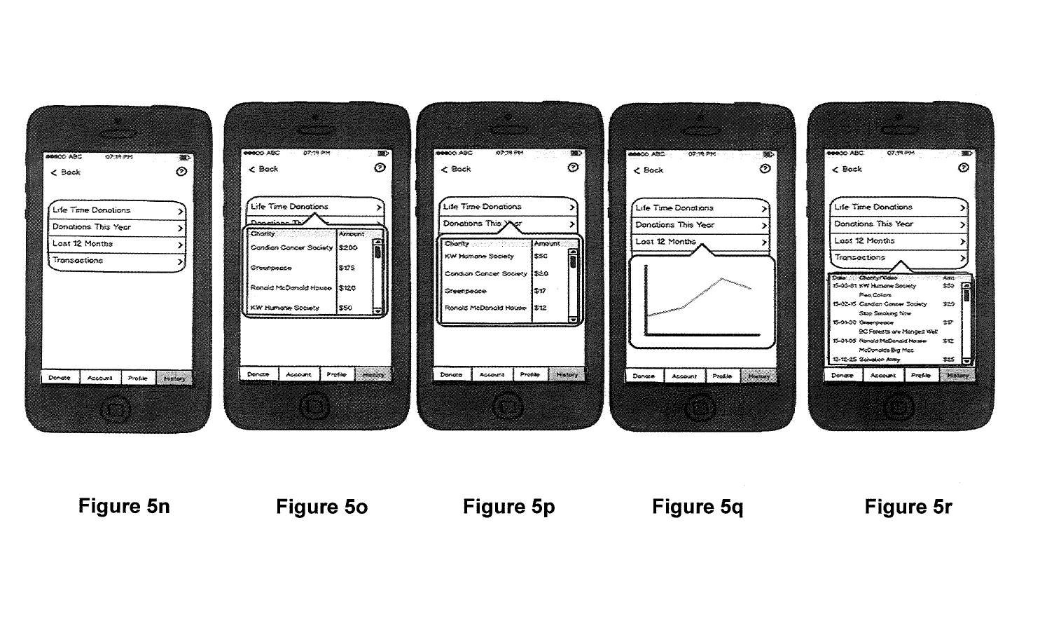

When a user decides to sign-in or login, the system displays the initial start-up screen to the user. An example of such a screen may be seen in FIG. 5a. If the user decides just to donate without logging in to the system, the system displays a Just donate screen which is schematically shown in FIG. 5b.

Assuming the user has an account and wishes to login, the user can enter their userid and password to login (200) via a login screen such as schematically shown in FIG. 5h. If the user has forgotten their password, they may be prompted with a series of Forgot Password screens, such as schematically shown in FIGS. 5i and 5j. In another embodiment, the user has the option of having the system remember the login information and can automatically sign the user in when the system is launched or initiated. If a user wants to sign-up (202) and register for using the system, the system may provide a screen to ask for demographic and basic information such as, but not limited to, Userid (email address), Password, to verify the password, Forgotten password challenge question and answer, First and last name, Birth year, Gender, Location, Education, or Employment. An example screen is schematically shown in FIG. 5l. The user is then requested to accept the terms and conditions of service (204) before the account is created and all the information is saved (206).

If a user decides to browse/search charities (208), the user is able to select criteria by which the charities are to be filtered for display. Information relating to all of the charities may be stored in and retrieved from the database. Searching criteria may include, but is not limited to Category/Sub-Category (as schematically shown in FIGS. 5k and 5m), International/National/Regional, or lists such as top 10 selected charities, trending charities etc. A list of charities matching the search criteria or filtering is then retrieved and displayed to the user.

In the preferred embodiment, tapping on a charity entry will display the details of the charity to the user. The user can make one of the charities their favorite or select a charity to receive a donation (210). If the user has not logged in to the system prior to charity selection, the user may be required to login (212) or register (if they do not have an account).

Alternatively, the browsing of charities (214) and the selection of a charity to donate to (216) may be performed after a user has logged in (as reflected by the shaded blocks of FIG. 3).

If the user is logged in, the user may click on a Donate button (216) in order to engage the system to view advertising content. When the user taps the donate button, advertising content, preferably in the form of a video commercial, will be played (220) on a user's device. For example, the system may display a watch screen (such as schematically shown in FIG. 5c) to the user. In the preferred embodiment, the advertising content is retrieved from the media server. After viewing the video, the user is requested to answer a short quiz (222) (schematically shown in FIG. 5d) preferably including a set of multiple-choice questions. If the user passes the test, a donation will be made to their selected charity (224) from the owner of the advertising content. An example donation completed screen is schematically shown in FIG. 5g. Depending if the user passed or failed the quiz, the system displays one of the quiz results screens (schematically shown in FIGS. 5e and 5f) to the user. The video commercial that is played is selected randomly from a list that meets or matches the demographics of the user. In a preferred embodiment, a count will be maintained on how often a user has watched a video commercial so that unseen videos will more likely be selected.

When logged in, the user can also Review/Update Profile (226) which allows the user to review their profile and make changes as required, delete their account or temporarily disable it; Review History (228) which allows the user to review the list of charities the user has made donations to; Logout (230) which allows the user to log out of the system and return to the login screen; and About (232) which allows the user to learn more about the software application or system. FIGS. 5n to 5r show example screens for reviewing the user's donation history. Whether the user is logged in or not, the user can access a Help/FAQ section (234) or contact the administrator (236).

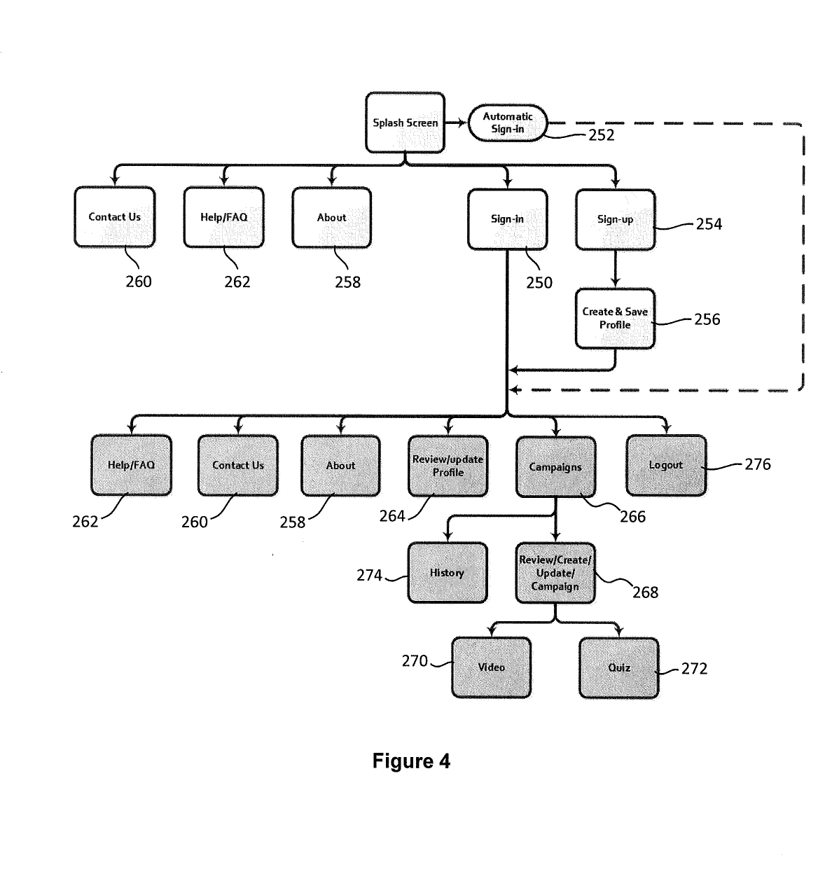

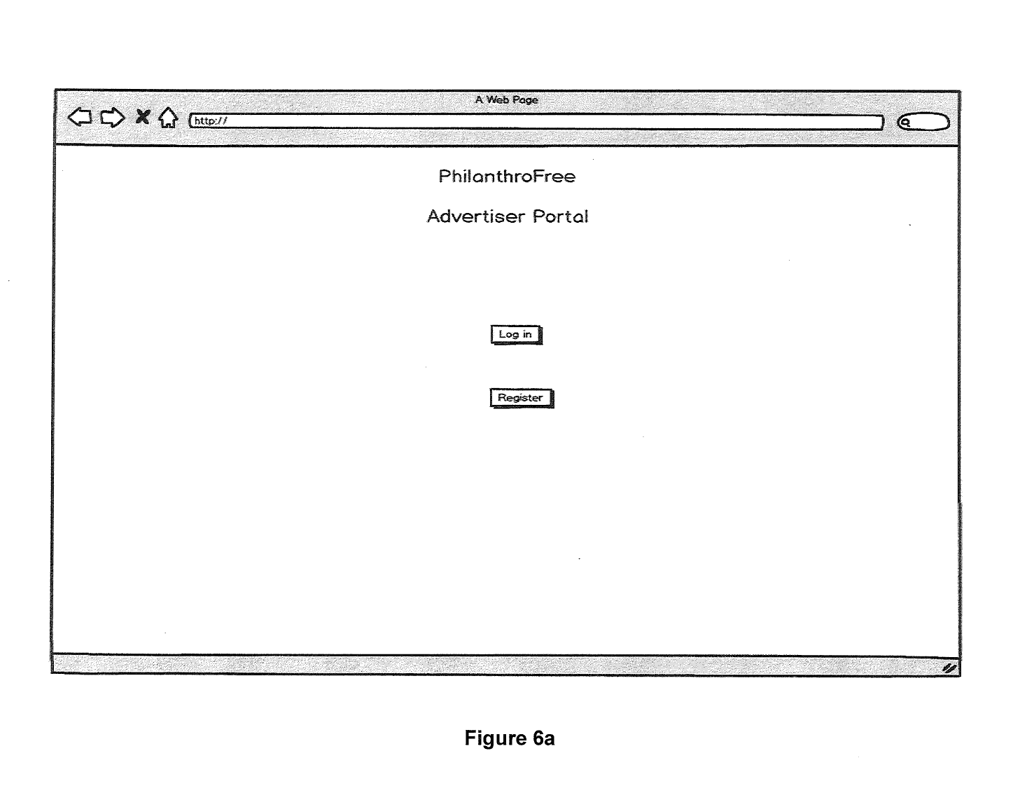

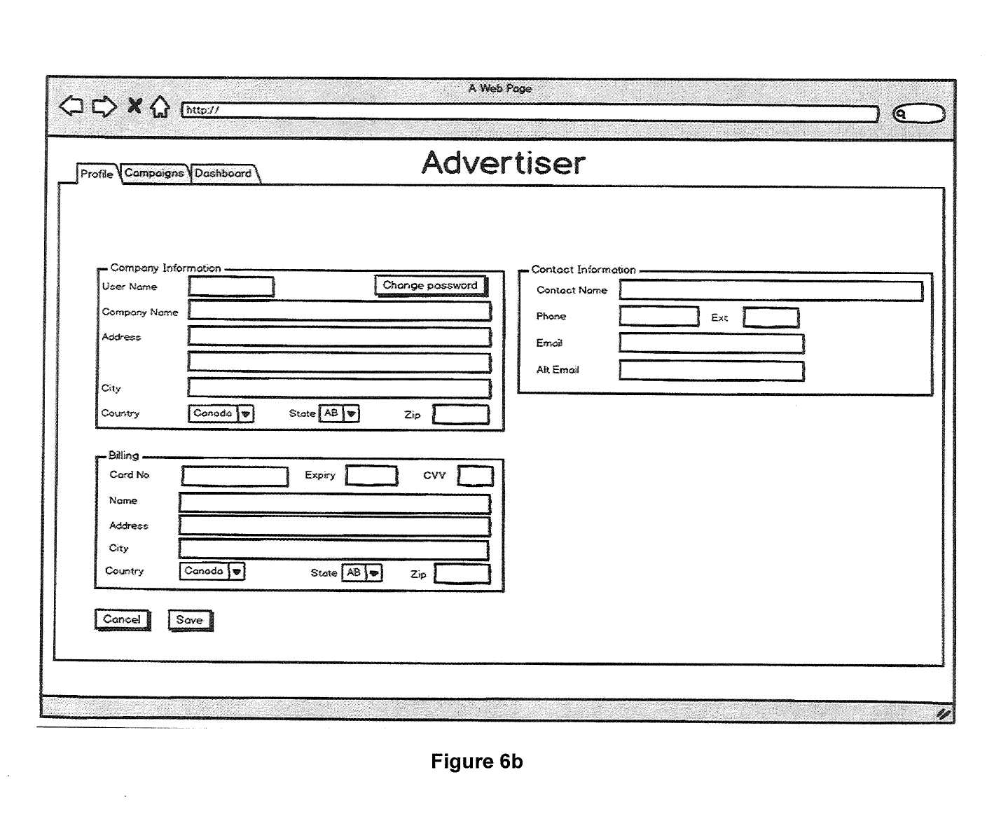

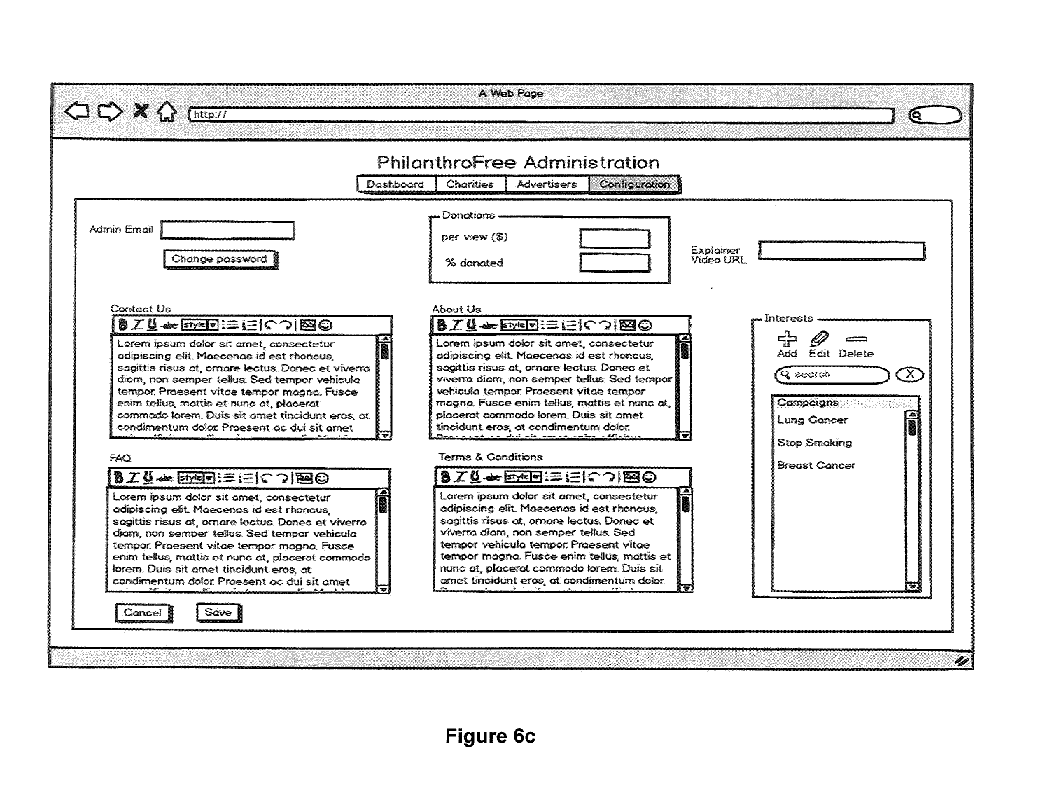

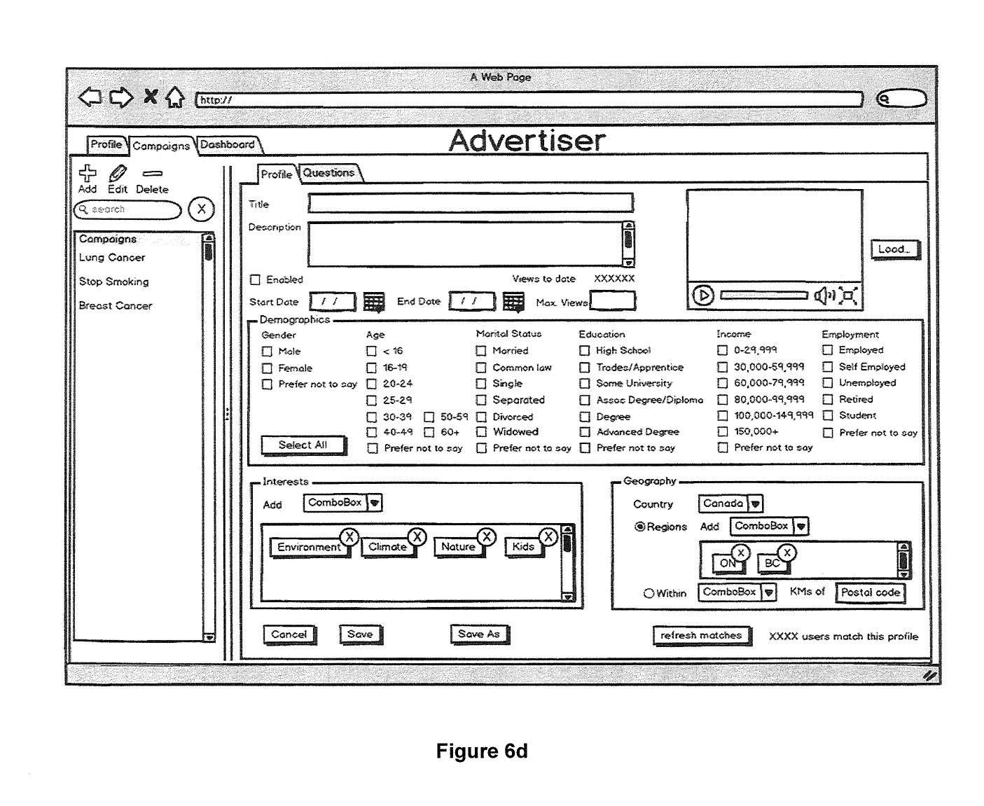

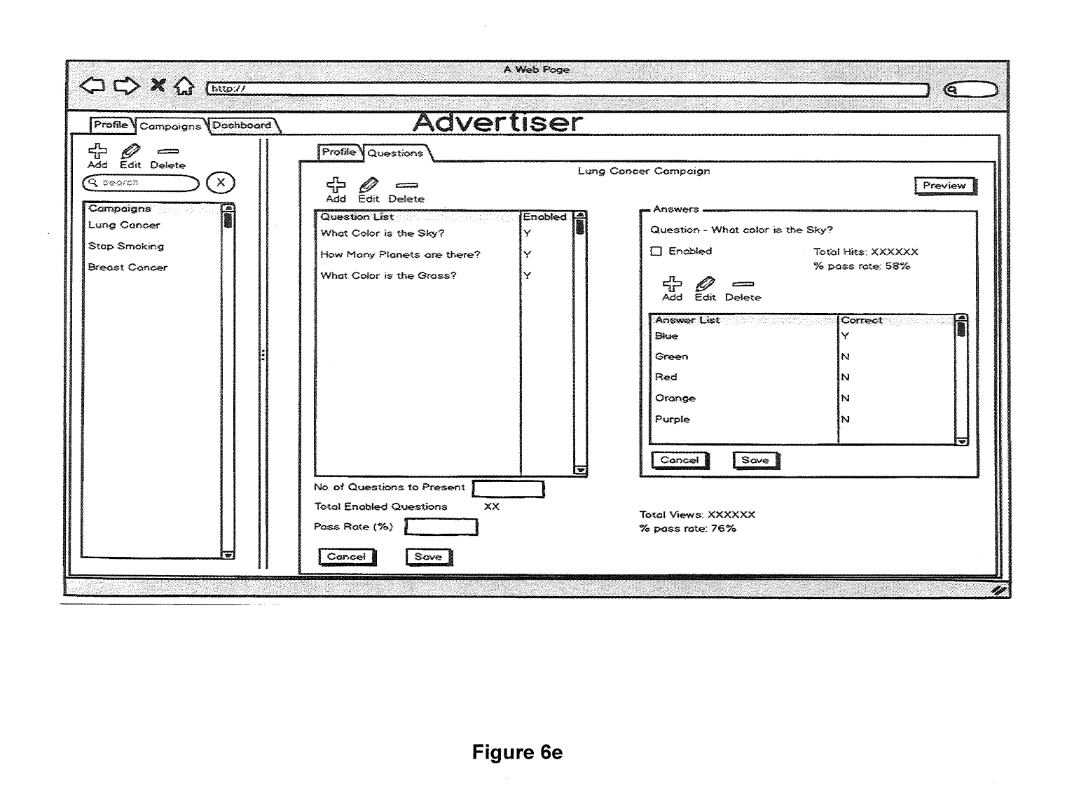

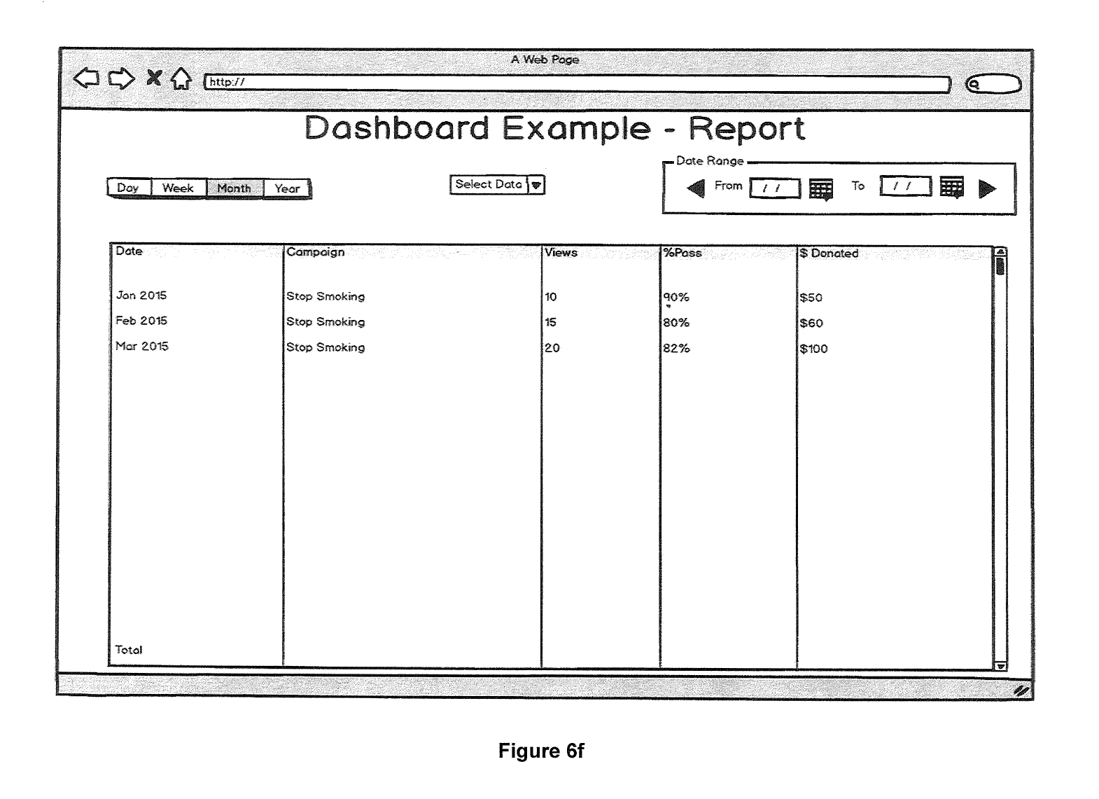

Turning to FIG. 4, a schematic diagram of the general organization of the workflow for an advertiser is shown. After being displayed a splash screen, the advertiser may be prompted to Sign-in (250) whereby if the advertiser already has an account they can enter their userid and password or to register (such as schematically shown in FIG. 6a). The advertiser has the option of having the software application remember these and automatically sign in when the software application is launched (252). The advertiser may also be allowed to Sign-up (254) whereby if the advertiser does not have an account they can create one. If the advertiser needs to get registered, the advertiser may be provided with a register screen such as schematically show in FIG. 6b. In registering, the advertiser is prompted to enter basic information such as, but not limited to, user id, Password, Verify password , Forgotten password challenge question and answer, Company name, First and Last name of contact, Address, Office phone, Email address, and/or Credit card information. After the information is entered, the system, or administrator, checks to make sure the userid is available and also checks that the email is not in use by another userid. The advertiser must accept the terms of service before the account is created and all the information is saved (256). As with the user, the advertiser may also learn more about the system via the About (258) section, contact the administrator of the system via the Contact Us (260) section or review the Help/FAQ section (262) for further information about the software application or system via a screen such as schematically shown in FIG. 6c.

After the advertiser has logged in (as reflected by the shaded blocks in FIG. 4), the advertiser may Review/Update Profile (264) which allows the advertiser to review their profile and make changes as required or to delete or temporarily disable their account or re-enable it. The user may also access a Campaigns (266) section which allows the advertiser to manage the campaign posting process. The campaigns may be created using campaign creation screens such as schematically shown in FIGS. 6d.

The advertiser may then access the Review/Create/Update Campaign section (268) to review the details for the campaign item so that the advertiser can make changes, if necessary. When creating a campaign, the advertiser loads the advertising quiz (272) along with the score required for a pass such as via the example screen of FIG. 6e. The advertiser may also specify start and end dates of a campaign, limit the maximum number of hits or views of the advertising content, and thereby donation amount, charity categories or the demographics of users they wish to have the advertising content supplied to. In a preferred embodiment, the advertiser has access to a dashboard that show statistics about each campaign, based on charities and demographics of users as well as hits within a given timeframe. The advertiser can also review a History section (274) which lists the expired campaigns so that the advertiser may review the details such as number of hits and cost. An example dashboard view of the History section is schematically shown in FIG. 6f. Finally, the advertiser may logout via the Logout section (274).

When logged in, the advertiser may also learn more about the system via the About (258) section, contact the administrator of the system via the Contact Us (260) section or review the Help/FAQ section (262) for further information about the software application or system.

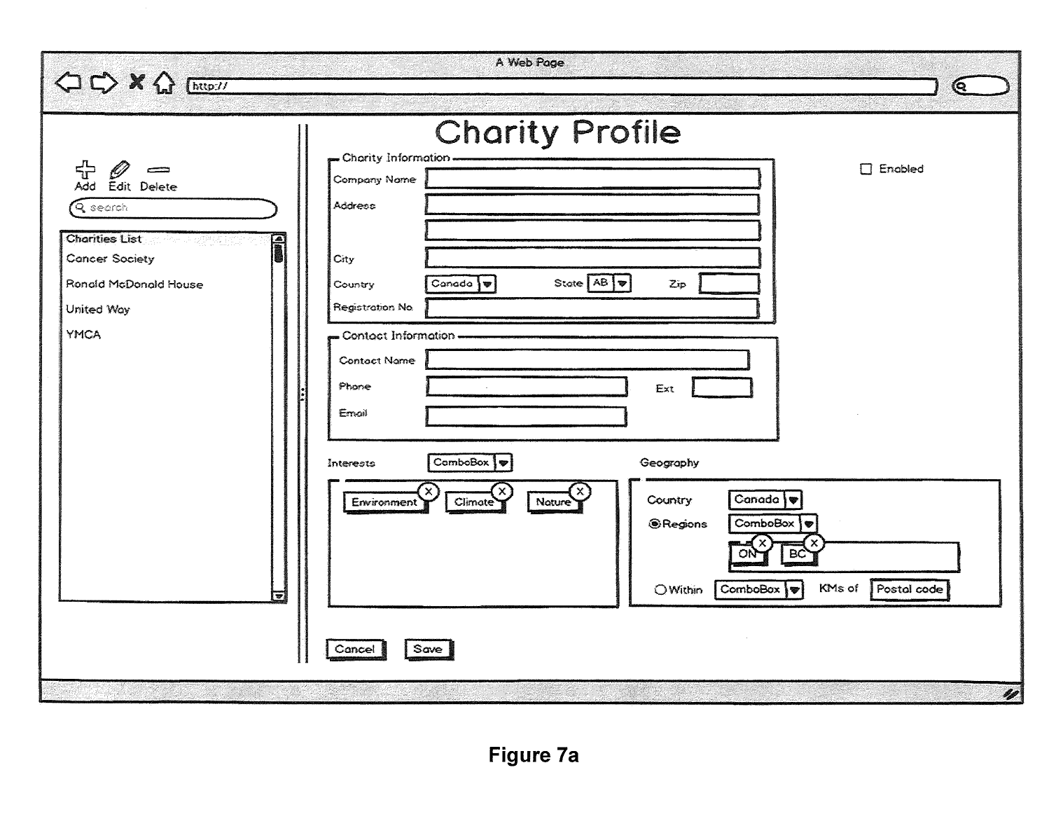

Charities may also register with the system in order to be one of the organizations which may receive donations from the users. Charities may register using a charity profile page (such as schematically shown in FIG. 7a).

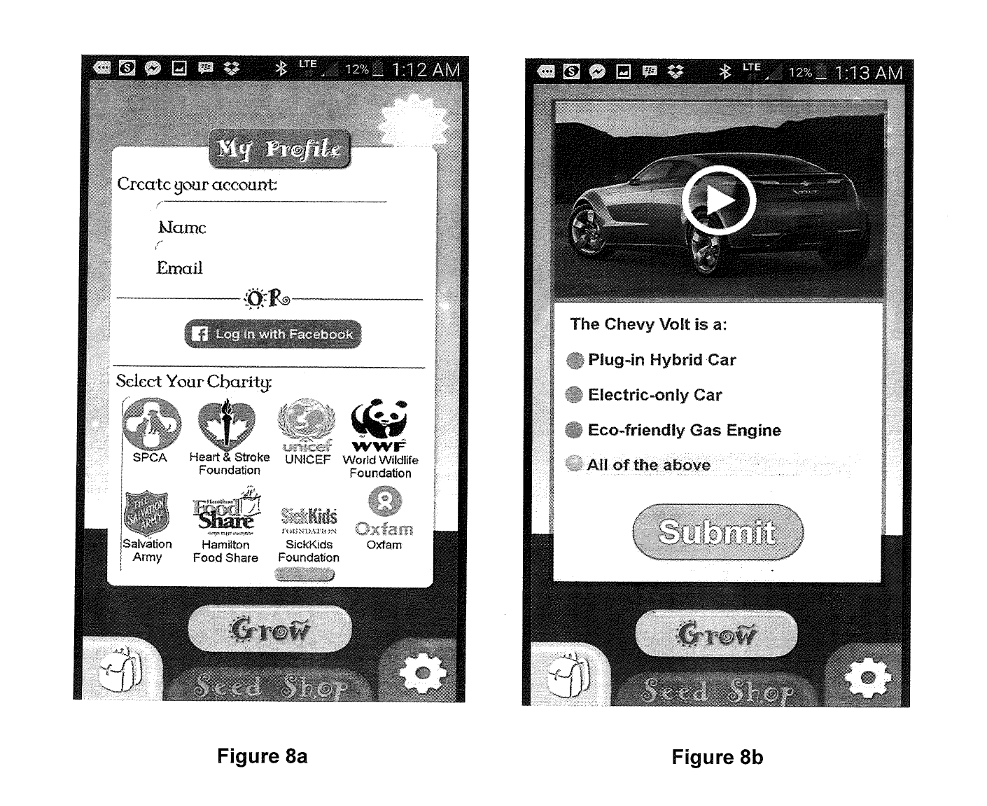

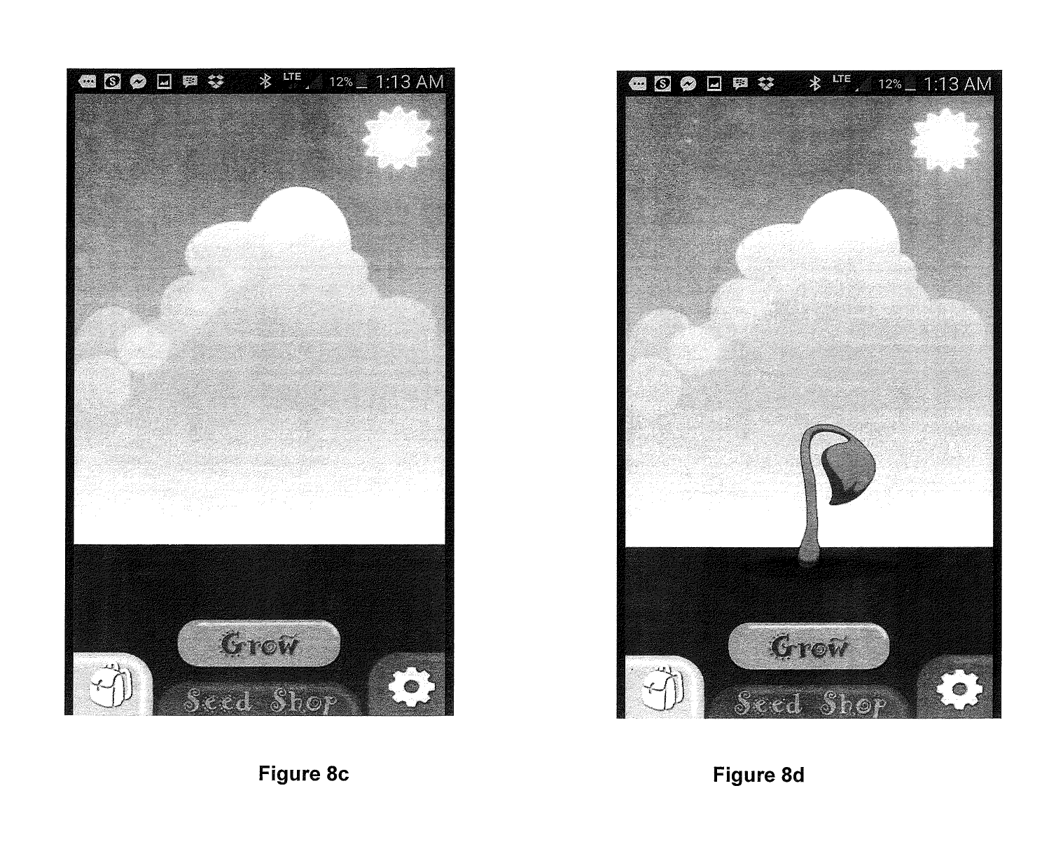

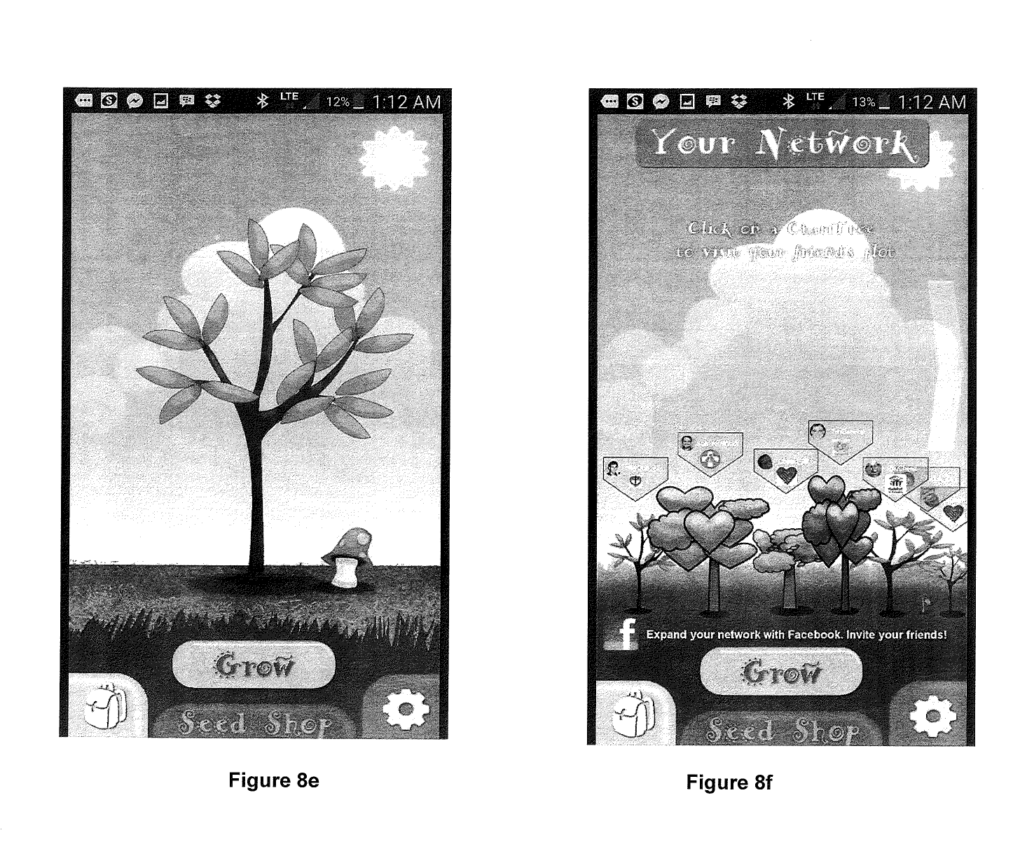

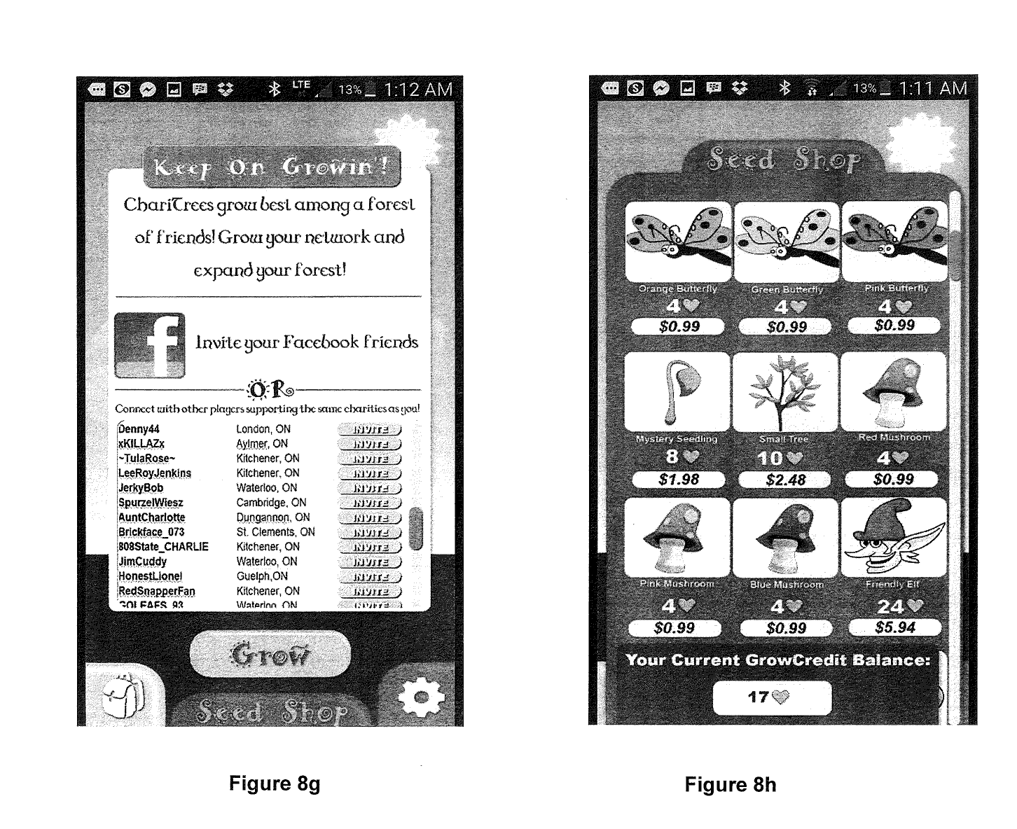

In an alternative embodiment, the software application may be “gameified” by keeping score of the amount of advertising content watched and sharing this with other users to create some competition amongst users and increase donation amounts. Gameified is the concept of applying game design thinking to non-game applications to make them more fun and engaging. FIGS. 8a to 8h provide example screens shots of the system in a gameified model. While not all screens are show, FIGS. 8a to 8h are meant to be examples of how a gamified system may look visually to a user.

FIG. 8a is an example screen shot of a gameified login screen for the system of philanthropy while FIG. 8b is an example screen of a quiz screen. FIG. 8c is a screen shot of a garden area where users may plant seeds or grow flowers once they have made a donation. FIGS. 8d and 8e reflect the garden after a donation, or multiple donations, have been given. A user may also decide to combine their garden with the garden of other users or friends within the system such as schematically shown in FIG. 8f. The user may also be provided with an opportunity to invite friends or to see a list of other users of the system who are supporting the same charities as the user. This example screen is schematically shown in FIG. 8g. The user may also buy other items to add to their garden via a seed shop screen , as shown in FIG. 8h.

In an alternative embodiment, a user may donate direction to a charity or multiple charities without having to interact with the advertising content. In another embodiment, the system may include apparatus for providing a charity spotlight whereby users are able to learn more about other charities such that lesser known charities may be highlighted to the users of the system for philanthropy. In another embodiment, a user may be a donating team such as a school in a geographic region. In a further embodiment, the system may include a charity statistics screen whereby information such as, but not limited to, donations, global donations, donation groups and donation teams may be displayed.

In a further embodiment, a user device may include an option of having a banner displayed such that the user may decide the frequency for ongoing passive donations. In another alternative embodiment, the system may include apparatus for charities or advertisers to give away prizes, coupons toward purchases and the like or to provide daily draws and/or prize giveaways. In yet another embodiment, the system may provide apparatus for the user to donate more to the charity by purchasing the product that was advertised to them and scanning a verification code or UPC.

In the preceding description, for purposes of explanation, numerous details are set forth in order to provide a thorough understanding of the embodiments. However, it will be apparent to one skilled in the art that these specific details are not required. The above-described embodiments are intended to be examples only. Alterations, modifications and variations can be effected to the particular embodiments by those of skill in the art without departing from the scope, which is defined solely by the claims appended hereto.

What is claimed is:

1. A method of providing a philanthropy tool comprising:
receiving a selected charity input from a user;
transmitting advertising content for review by the user;
receiving confirmation that a user has reviewed the advertising content; and
making a donation to the selected charity by connecting to a server associated with the charity.

2. The method of claim 1 wherein receiving confirmation comprises:
transmitting a quiz to the user based on the advertising content; and
receiving confirmation that the user has passed the quiz.

3. The method of claim 1 further comprising, before making a donation:
assigning a donation value to a user based on the confirmation that the user has reviewed the advertising content;
adding the donation value to donation total previously amassed by the user; and
determining total donation collected by the user.

4. The method of claim 3 wherein assigning a donation value comprises:
retrieving the donation value associated with the advertising content reviewed by the user.

5. The method of claim 1 wherein transmitting advertising content comprises:
transmitting a video for review by the user.

6. The method of claim 1 wherein transmitting advertising content comprises:
transmitting an audio file for review by the user.

7. The method of claim 1 wherein transmitting advertising content comprises:
transmitting a poster for review by the user.

8. The method of claim 1 wherein receiving a select charity input comprises:
providing a list of approved charities to the user; and
receiving selection of at least one charity from the list of approved charities.

9. The method of claim 1 wherein transmitting advertising content comprises:
retrieving advertising content from a server; and
displaying advertising content to user.
